(19) United States
(12) Patent Application Publication
(10) Pub. No.: US 2007/0116897 A1
(43) Pub. Date: May 24, 2007

(54) Liquid crystal display apparatus

(75) Inventor: Feng-Li Lin, Taishan Township (TW)

Correspondence Address: BIRCH STEWART KOLASCH & BIRCH, PO BOX 747, FALLS CHURCH, VA, 22040-0747, US

(73) Assignee: GIGNO TECHNOLOGY CO., LTD.

(21) Appl. No.: 11/603,172

(22) Filed: Nov. 22, 2006

(30) Foreign Application Priority Data
Nov. 24, 2005 (TW) 094141365

(51) Int. Cl. G02B 5/20; G02F 1/1335; C09K 19/00

(52) U.S. Cl. 428/1.1; 349/106; 430/20

(57) ABSTRACT

A liquid crystal display apparatus, which has a color filter, is characterized in that the color filter is doped with a spectrum absorbing material. The spectrum absorbing material at least has an absorbing peak between 560nm and 590nm.

### BACKGROUND OF THE INVENTION

1. Field of Invention

The invention relates to a flat display apparatus and, in particular, to a liquid crystal display apparatus.

2. Related Art

Recently, electronic technology has been progressing rapidly, and portable electronic products are diversifying, resulting in increasing demands on the display apparatuses for light weight, compactness, and energy efficiency. Liquid crystal display apparatuses, which are among the most popular display apparatuses, have the advantages of low power consumption, low heat generation, light weight, and no radiation emission, and thus are used in various kinds of electronic products to replace the conventional CRT display (Cathode Ray Tube Display).

FIG. 1 shows a conventional liquid crystal display apparatus. As shown in FIG. 1, a liquid crystal display apparatus 1 mainly includes a backlight module 11, a first polarizer 12, a second polarizer 13, a pair of substrates 14, 14′, a liquid crystal layer 15, and a color filter 16. The backlight module 11 emits light, and the light reaches the first polarizer 12. By selection of the first polarizer 12, only a part of the light polarized in a first predetermined direction can pass through the substrates 14, 14′, which have the liquid crystal layer 15 disposed therebetween. The arrangement of the liquid crystal molecules in the liquid crystal layer 15 can be changed by driving the liquid crystal layer 15. Thus, when the light passes through the liquid crystal layer 15 and reaches the second polarizer 13, the polarization direction of the light may be turned to a second predetermined direction. Only the light in the second predetermined direction can pass through the second polarizer 13 and then reach the color filter 16 disposed on the glass substrate 17. When the light passes through the R, G, or B pixel of the color filter 16, the user can obtain the desired color image based on the visual persistence.

In the prior art, cold cathode fluorescent lamps (CCFLs) are usually used to construct the backlight module 11 of the liquid crystal display apparatus 1. As shown in FIG. 2, a conventional CCFL 20 includes a glass tube 21, two electrode layers disposed at two ends of the glass tube 21, and a phosphor layer 23 disposed on the inner wall of the glass tube 21. The glass tube 21 is filled with mercury steam and mixed inert gases such as xenon and argon, which are used as the discharge medium. When the CCFL 20 is lighted, the electrode layer 22, which is connected to the power source through the wire 221, releases electrons. Then, the electrons are speeded by the electric field. By collision of the electrons and the discharge medium, the discharge medium turns to an excited state. After releasing ultraviolet light, the discharge medium may return to a ground state. The released ultraviolet light is absorbed by the phosphor layer 23, and then the phosphor layer 23 emits visible light.

The CCFL 20 has a spectrum as shown in FIG. 3. The three major peaks are respectively representing the bandwidths of blue light, green light and red light. As shown in FIG. 3, the visible light emitted from the phosphor of the CCFL further includes the bandwidths of other colors which are the minor peaks indicated by the arrows. The minor peak (about 560 nm to 590 nm) located between the red light and green light usually occur due to the disposition of the mercury steam and green phosphor in the CCFL 20. This minor peak usually decreases the purity of red light and green light of the CCFL and thus reduces the color saturation of the liquid crystal display apparatus.

Therefore, it is an important subject of the invention to provide a liquid crystal display apparatus with the CCFL as the backlight module that can reduce the light of the minor peaks.

### SUMMARY OF THE INVENTION

In view of the foregoing, the invention is to provide a liquid crystal display apparatus having improved color saturation.

To achieve the above, the invention discloses a liquid crystal display apparatus, which includes a color filter. The liquid crystal display apparatus is characterized in that the color filter is doped with a spectrum absorbing material. The spectrum absorbing material has at least one absorbing peak between 560 nm and 590 nm.

As mentioned above, the liquid crystal display apparatus of the invention includes a spectrum absorbing material doped in the color filter for absorbing light of 560 nm to 590 nm, which is a color of light other than red, green or blue light. Compared with the prior art, the liquid crystal display apparatus of the invention includes the color filter doped with the spectrum absorbing material for absorbing light of minor peaks, so that the color saturation of the liquid crystal display apparatus can be improved. This improvement can induce the customer to by our products, and thus increase the sale amount of the products.

### BRIEF DESCRIPTION OF THE DRAWINGS

The invention will become more fully understood from the detailed description given herein below illustration only, and thus is not limitative of the present invention, and wherein:

FIG. 1 is a schematic view showing the conventional liquid crystal display apparatus;

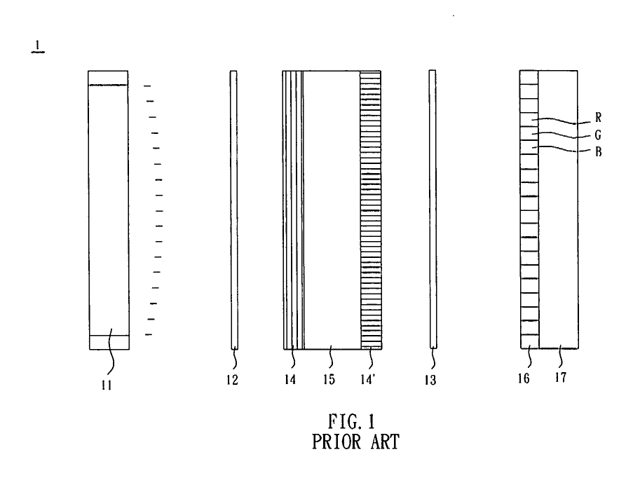

FIG. 2 is a schematic view showing the conventional CCFL;

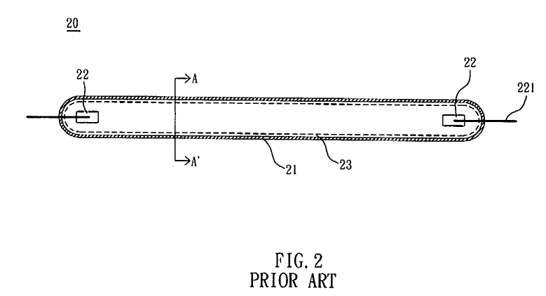

FIG. 3 is a schematic view showing the spectrum diagram of the light emitted from the CCFL;

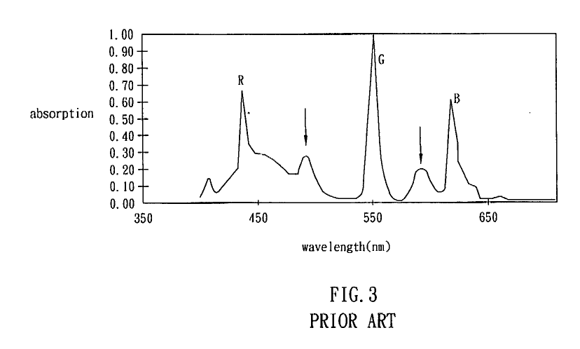

FIG. 4 is a schematic view showing a liquid crystal display apparatus according to a preferred embodiment of the invention;

FIG. 5 is a schematic view showing a color filter of the liquid crystal display apparatus according to the embodiment of the invention; and

FIG. 6 is a schematic view showing an absorption spectrum diagram of a spectrum absorbing material S.

### DETAILED DESCRIPTION OF THE INVENTION

The present invention will be apparent from the following detailed description, which proceeds with reference to the accompanying drawings, wherein the same references relate to the same elements.

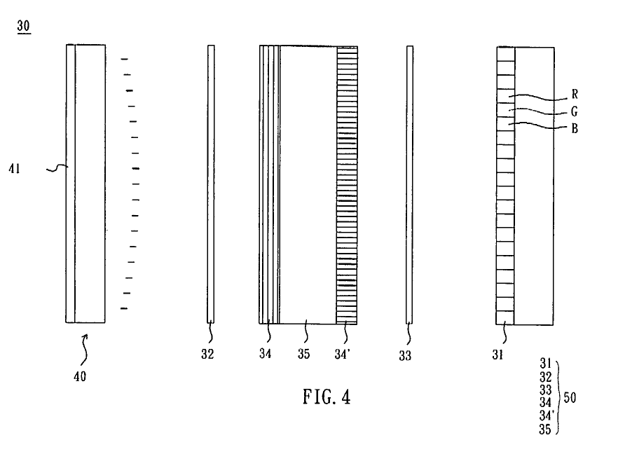

Please refer to FIG. 4 to FIG. 6, illustrating a liquid crystal display apparatus according to a preferred embodiment of the invention.

With reference to FIG. 4, a liquid crystal display apparatus 30 includes a color filter 31, which is doped with a spectrum absorbing material S. The spectrum absorbing material S has at least one absorbing peak between 560 nm and 590 nm.

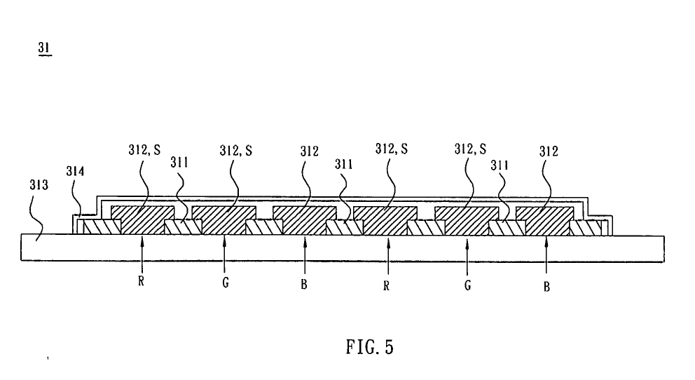

With reference to FIG. 5, the color filter 31 includes a black matrix 311 and a plurality of color photoresistors 312. The black matrix 311 defines a plurality of sub-pixel areas (R, G, and B). The color photoresistors 312 are formed on the sub-pixel areas (R, G, and B) to cover part of the black matrix 311. The spectrum absorbing material S is doped into at least one of the color photoresistors 312. If the spectrum absorbing material S is, for example, Neodymium Oxide (Nd2O3), it may be doped into the green photoresistors or the red photoresistors.

In this embodiment, the black matrix 311 and the color photoresistors 312 may be disposed on a transparent substrate 313, and then a transparent conductive file 314 covers the black matrix 311 and the color photoresistors 312. The black matrix 311 is usually made of chromium or chromium oxide. The color photoresistors 312 are usually composed of resin, which is combined with pigment or dye of different colors and then doped with the spectrum absorbing material S.

With reference to FIG. 4 again, the liquid crystal display apparatus 30 may further include a backlight module 40, which includes a lamp 41.

Moreover, the liquid crystal display apparatus 30 may further include a first polarizer 32, a second polarizer 33, two substrates 34, 34′, and a liquid crystal layer 35. In this embodiment, the color filter 31, the first polarizer 32, the second polarizer 33, the substrates 34, 34′, and the liquid crystal layer 35 construct a liquid crystal panel module 50. The backlight module 40 and the liquid crystal panel module 50 construct the liquid crystal display apparatus 30.

The backlight module 40 emits light, and the light reaches the first polarizer 32. By selection of the first polarizer 32, only a part of the light polarized in a first predetermined direction can pass through the substrates 34, 34′, which have the liquid crystal layer 35 disposed therebetween. The arrangement of the liquid crystal molecules in the liquid crystal layer 35 can be changed by driving the liquid crystal layer 35. Thus, when the light passes through the liquid crystal layer 35 and reaches the second polarizer 33, the polarization direction of the light may be turned to a second predetermined direction. Only the light polarized in the second predetermined direction can pass through the second polarizer 33 and then reach the color filter 31. When the light passes through the R, G, or B pixel of the color filter 31, the user can perceives the desired color image based on visual persistence.

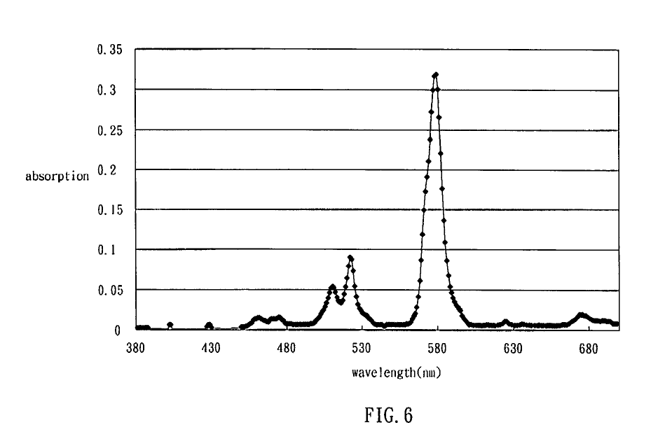

FIG. 6 shows the absorption spectrum diagram of the spectrum absorbing material S, which dopes in the color filter 31. With reference to FIG. 6, the spectrum absorbing material S has an absorbing peak located between 560 nm and 590 nm. Thus, after the light enters the color filter 31, the spectrum absorbing material S of the color filter 31 can absorb the light from 560 nm to 590 nm, which corresponds to the colors between green and red. Therefore, the color saturation of the liquid crystal display apparatus 30 can be improved.

In summary, the liquid crystal display apparatus of the invention includes a spectrum absorbing material doped in the color filter for absorbing light of 560 nm to 590 nm, which corresponds to colors of light other than red, green, or blue light. Compared with the prior art, the liquid crystal display apparatus of the invention includes the color filter doped with the spectrum absorbing material for absorbing light of minor peaks, so that the color saturation of the liquid crystal display apparatus can be improved. This improvement can induce the customer to by our products, and thus increase the sale amount of the products.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A liquid crystal display apparatus, which comprises a color filter, the liquid crystal display apparatus is characterized in that:
the color filter is doped with a spectrum absorbing material, wherein the spectrum absorbing material has at least one absorbing peak between 560 nm and 590 nm.

2. The apparatus of claim 1, wherein the spectrum absorbing material is Neodymium Oxide.

3. The apparatus of claim 1, wherein the color filter comprises a black matrix and a plurality of color photoresistors, the black matrix defines a plurality of sub-pixel areas, and the color photoresistors are formed on the sub-pixel areas to cover part of the black matrix.

4. The apparatus of claim 3, wherein the spectrum absorbing material is doped in at least one of the color photoresistors.
